(19) United States
(12) Patent Application Publication
(10) Pub. No.: US 2013/0198044 A1
(43) Pub. Date: Aug. 1, 2013

(54) AUTOMATED BROADCAST SYSTEMS AND METHODS

(71) Applicants: Elijah Forrest O'Connor, Cambridge, MA (US); Daniel Patrick Gurney, Cambridge, MA (US)

(72) Inventors: Elijah Forrest O'Connor, Cambridge, MA (US); Daniel Patrick Gurney, Cambridge, MA (US)

(73) Assignee: Concert Window LLC, Cambridge, MA (US)

(21) Appl. No.: 13/360,635

(22) Filed: Jan. 27, 2012

(51) Int. Cl. G06Q 30/06; H04N 21/643; H04N 21/25

(52) U.S. Cl. 705/27.1; 725/25; 725/109

(57) ABSTRACT

Automated broadcast from one or more physical venue locations is described. One system includes multiple automated broadcast sets, disposed on location at the physical venue locations, and one or more content delivery network servers. An automated broadcast set, disposed at each location of the physical venue locations, comprises a plurality of cameras, one or more optional microphones, and at least one router or a local computer. The cameras are pre-positioned at different sight angels within the corresponding physical venue location and are configured to automatically capture images. The optional microphones are pre-positioned at the corresponding physical venue location and automatically capture audio. The router or the local computer is configured to encode and transmit received video and audio signals over a network.

### HELD OF THE INVENTION

At least one embodiment of the present invention pertains to media distribution, and more particularly, to systems and methods for recording, managing, and distributing images and/or other content from live events generated from multiple cameras or sensors disposed on location at each of a plurality of physical venue locations.

### BACKGROUND

Live performances have been very popular for many years. Each year, hundreds of millions audiences attend live performances at a variety of venues, such as stadiums, auditorium halls, parks, bars etc. Audiences find live performances attractive. Unlike performances recorded in a studio, live performances involve exchanges between performers and their audiences. For example, performers often interject comments between episodes and audiences often react to such comments with applauses, cheering, etc.

The explosive growth of technologies and the Internet has made it possible for audiences to experience live performances on TVs or computers at home. Live performances may be broadcast through a single personal computer (PC) camera from one Internet user to other users. However, the quality of such single camera broadcasting is normally not good. Performers are limited to a small area in front of the single PC camera. In addition, an operator is required to control the PC camera. On the other hand, if a high quality video broadcast is desired, such broadcast typically requires professional video cameras on pedestals, one or more camera operators, stage lighting rigs and the associated control equipment, etc. This type of video broadcasting is not only expensive but also intrusive for small venues.

In consequence, the present inventor has recognized that there is value in having a high quality automated broadcast system, including non-intrusive cameras. The present inventor has identified a need to automatically broadcast live performances with high image quality at a variety of physical venues and provide network users an option to search and watch such live performances over the Internet.

### SUMMARY

The present disclosure provides a variety of teachings for an automated broadcast system. One automated broadcast system includes a plurality of automated broadcast sets and a content delivery network server. An automated broadcast set may be disposed on location at each of a plurality of physical venue locations. Each physical venue location is configured to host live events. The present disclosure is not limited to an automated broadcast system operable at multiple physical venue locations. Those skilled in the art will appreciate that the principles of the present disclosure can be used in an automated broadcast system operable at a single physical venue location.

The automated broadcast set may comprise a plurality of cameras, and at least one router and/or a local computer. In some implementations, the automated broadcast set may further comprise one or more optional microphones. The plurality of cameras may be pre-positioned at different sight angles within the corresponding physical venue location and configured to automatically capture images from live events at the corresponding physical venue location. The one or more optional microphones may be pre-positioned at the corresponding physical venue location and configured to automatically capture audio from the live events. The at least one router or the local computer may have one or more IP address(es) and may be configured to receive video signals from the plurality of cameras and/or receive audio signals from the one or more optional microphones. The at least one router or the local computer may be configured to encode and transmit received audio signals and video signals over a network. Other sensors, such as motion sensors, may be disposed on location for this information encoded for transmission.

The content delivery network server, coupled to the network, may be configured to receive and decode the encoded audio signals and video signals from each automated broadcast set. The content delivery network server may be further configured to receive requests from a plurality of network users for substantially real-time access to live events at the plurality of physical venue locations, and broadcast to the network users selected live events upon authorized payments or subscriptions. As will be appreciated by those skilled in the art, the content delivery network server may comprise multiple servers. In some implementations, one or more these multiple servers may be configured to receive and decode the encoded information of live events. In some implementations, one or more these multiple servers may be configured to receive requests from network users and broadcast selected live events in substantially real-time to subscribers or paid customers. In some implementations, these multiple servers may be located at the same physical location. In some implementations, these multiple servers may be located at multiple physical locations.

In one embodiment of the present disclosure, one or more computer program(s), stored on the content delivery network server, may be configured to allow server operator(s) or venue manager(s) to schedule automated capture of a live event at the corresponding physical venue location. The computer program(s) may comprise: instructions to turn on the plurality of cameras and/or the one or more optional microphones at the corresponding physical venue location at the beginning of a scheduled time period, wherein the scheduled time period may be preset by server operator(s) and/or venue operator(s); instructions to transmit the audio signals from the one or more optional microphones to the at least one router and/or the local computer; instructions to transmit the video signals from the plurality of cameras to the at least one router and/or the local computer at the corresponding venue location according to a predetermined pattern, wherein the predetermined pattern may be preset by the server operator(s) and/or the venue operator(s); instructions to encode the video signals and the audio signals for transmission over the network; instructions to transmit encoded video signals and encoded audio signals to the content delivery network server over the network; instructions to receive encoded video and audio signals and decode received signals; and instructions to turn off the plurality of cameras and the one or more optional microphone(s) at the corresponding physical venue location of the live event at the end of the scheduled time period.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a schematic block diagram of an automated broadcast system according to one embodiment(s) of the present disclosure.

FIG. 2 is a flow diagram of a process for automatically broadcasting live events on a network according to another embodiment(s) of the present disclosure.

FIG. 3 illustrates a schematic block diagram of a content delivery network server according to yet another embodiment(s) of the present disclosure.

FIG. 4 is a flow diagram of a process for automatically recording live events at a plurality of physical venues according to yet another embodiment(s) of the present disclosure.

### DETAILED DESCRIPTION

References in this specification to “an embodiment”, “one embodiment”, or the like, mean that the particular feature, structure or characteristic being described is included in at least one embodiment of the present disclosure. Occurrences of such phrases in this specification do not necessarily all refer to the same embodiment.

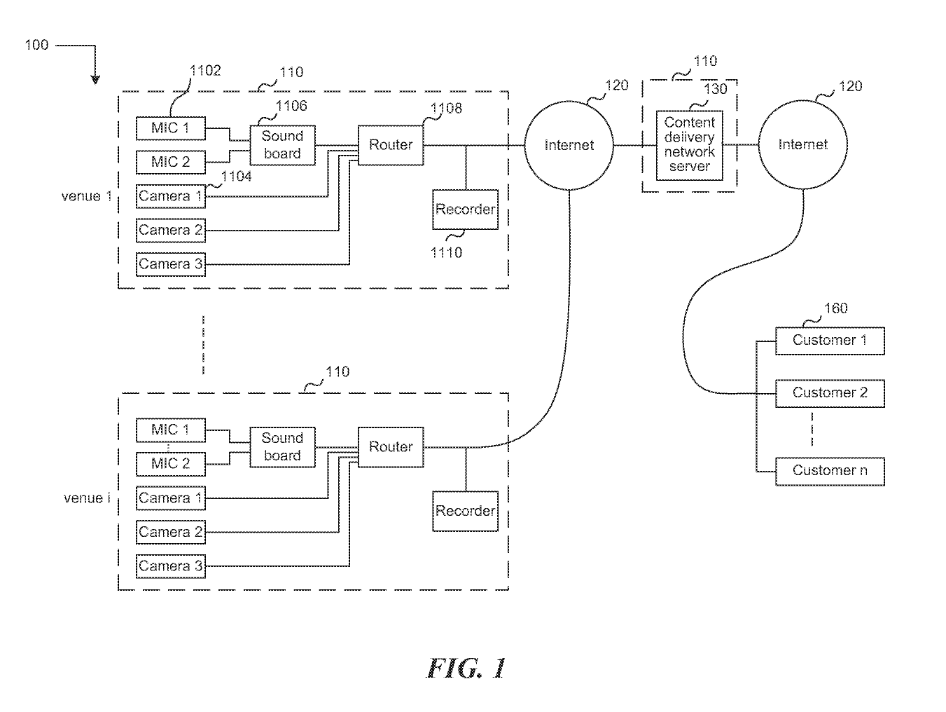

FIG. 1 illustrates a schematic block diagram of an automated broadcast system 100 according to one embodiment(s) of the present disclosure. The automated broadcast system 100 may include a plurality of automated broadcast sets 110 and a content delivery network server 130. An automated broadcast set 110 may be disposed on location at each of a plurality of physical venue locations. The plurality of physical venues may include, but not limited to, clubs, public houses, concert halls, outdoor bandstands, home venues etc. In some implementations, the automated broadcast set 110 may be disposed at its corresponding physical venue location through a lease. In some implementations, the automated broadcast set 110 may be owned by its corresponding physical venue. Each of the plurality of physical venue locations is configured to host live events. The automated broadcast set 110 may include a plurality of cameras 1104, and one or more routers 1108.

The plurality of cameras 1104 may be pre-positioned at different sight angles for live events at each physical venue location. The cameras 1104 may be installed at desired locations and adapted to each specific physical venue. In some implementations, the cameras 1104 may be installed non-intrusively to performers and audiences of live events at each specific physical venue. In some implementations, at least one camera of the plurality cameras 1104 may be configured to provide a wide master shot of the entire stage and capture overall live events at the corresponding physical venue location. In some implementations, one of the plurality cameras 1104 may be configured to provide close-up image(s) of leading performer(s) of live events at the corresponding physical venue location. In some implementations, the cameras 1104 may be professional high quality cameras.

The cameras 1104 are coupled to the router 1108 and/or a local computer via a wired or wireless communications mechanism in a manner well known in the art. For instance, the cameras 1104 may be connected to the router 1108 and/or the local computer via camera cables. In some implementations, the cameras 1104 may be coupled to the router 1108 and/or the local computer via a Wi-Fi mechanism. Wi-Fi allows electronic devices to exchange date wirelessly and connect to a network resource, such as the Internet, via a wireless network access point.

In some implementations, the cameras 1104 may be operable to generate 30 frames or more digital images per second and may be turned on and off automatically. The cameras 1104 may be programmed to automatically capture images from live events at the corresponding physical venue locations and transmit video signals according to a particular pattern. In some implementations, the particular pattern may include automatically switching between the cameras with different sight angles after a fixed period of time, such as every 30 seconds. In some implementations, the particular pattern may be an event specific pattern that may be preset by an operator of the server 130 and/or a manager of the corresponding physical venue location. In some implementations, the pan angles, the tilt angles, and the zoom ratios of the cameras 1104 may be programmed and automatically controlled.

In some implementations, the automated broadcast set 110 may further include one or more optional microphones 1102. The one or more optional microphones 1102 may be turned on and off automatically and configured to automatically capture audio from live events at the corresponding physical venue locations. The one or more optional microphones 1102 may be coupled to the router 1108 and/or the local computer via a wired or wireless communications mechanism in a manner well known in the art. For instance, the one or more optional microphone(s) 1102 may be connected to the router 1108 and/or the local computer via audio cables. In some implementations, the one or more optional microphones 1102 may be coupled to the router 1108 and/or the local computer via FM radio, infrared waves, or Wi-Fi mechanisms, In some implementations, the one or more optional microphone(s) 1102 may be connected to a sound mixer. The sound mixer may be coupled to a sound board 1106 that is coupled to the one or more router(s) 1108 and/or the local computer via a wired or wireless communications mechanism in a manner well known in the art. Automatically captured audio signals may be In some implementations, one optional microphone at a specific physical venue location may be pre-installed to capture audio of audience's response during live events at the specific venue location.

The one or more router(s) 1108 may have one or more Internet Protocol (IP) address(es). The IP address is associated with the location of the router(s) 1108 over the entire Internet. In some implementations, the automated broadcast set 110 may include a local computer. The local computer may have one or more IP addresses. The router(s) 1108 and/or the local computer are coupled to the plurality of cameras 1104 and/or the one or more optional microphones 1102 via cables and/or wireless connections at each physical venue location. In some implementations, the router(s) 1108 and/or the local computer may be configured to combine video signals from the cameras 1104 and audio signals from the optional microphone(s) 1102 and then encode and stream combined signals via the Internet 120. In some implementations, the router(s) 1108 and/or the local computer may be configured to further compress the combined video and audio signals before streaming them via the Internet 120.

In some implementations, the automated broadcast set 110 may include other optional sensors, such as motion sensors etc., disposed on location at the plurality of physical venue locations. The optional sensors are operable to control live image and audio recorded and/or transmitted from the plurality of physical venue locations. In some implementations, optional sensors are operable to turn on and/or turn off the plurality of cameras 1104 and the one or more optional microphones 1102 at the corresponding venue locations. In some implementations, optional sensors are operable to trigger the one or more router(s) 1108 and/or the local computer at the corresponding venue locations to transmit encoded video and/or audio signals over a network. Those of skill in the art will appreciate that these optional sensors are not limited to motion sensors. Other sensors, such as light sensors, vibration sensors, sound sensors, temperature sensors, etc., may be used to control live image and audio recorded and/or transmitted from the plurality of physical venue locations.

In some implementations, the automated broadcast set 110 may further include a recorder 1110. The recorder 1110 may be coupled to the plurality of cameras 1104, the one or more optional microphones 1102, and the router 1108. The recorder 1110 may be any medium device configured to store digital data, such as a hard drive, RAM, ROM, flash memory, CD-ROM, digital versatile disks (DVD), solid-state drive (SSD), or the like. The recorder may be configured to store video signals from the cameras 1104 and audio signals from optional microphone(s) 1102. In some implementations, the recorder may be configured to record video signals and audio signals at a specific physical venue location to facilitate an unexpected Internet breakdown and/or facilitate requests of broadcast delays.

The content delivery network server 130 is coupled to the Internet 120. In some implementations, the content delivery network server 130 may have one or more IP addresses. In some implementations, the content delivery network server 130 may comprise multiple content delivery network servers located at the same or multiple physical locations, The content delivery network server 130 may be configured to receive and decode live video and audio signals of a live event from the one or more router(s) 1108 and/or the local computer at the corresponding physical venue location. The content delivery network server 130 may be configured to encode live video and audio signals and stream them to customers via the Internet. In some implementations, the content delivery network server 130 may be configured to save video and audio signals of a specific live event and convert them to recordings. An option may be provided to an interested customer to purchase a copy of the recordings on the specific live event by paying a particular price.

In some implementations, the content delivery network server 130 may include a plurality of computer programs. The programs may be configured to allow an operator of the server 130 and/or venue managers to maintain a broadcast schedule of available live events at the plurality of physical venue locations. The schedule of available live events at each specific physical venue location may be created and/or modified by the server operator and/or a manager of the specific venue location. In some implementations, the programs may be configured to allow the server operator and/or the venue manager of a specific physical venue location to preset the broadcast schedule of a live event at the specific physical venue location, e.g. time, duration, etc. In some implementations, the programs may be configured to allow the server operator(s) and/or the venue manager(s) of a live event to preset a particular pattern that captured images are transmitted from the plurality of cameras to the router(s) 1108 and/or the local computer at the corresponding physical venue location. In some implementations, the programs may be configured to allow the server operator(s) and/or the venue manager(s) to preset the pan angle, the tilt angle, and the zoom ratio of a specific camera at the corresponding physical venue location. In some implementations, a local computer at a specific venue location may be configured to allow a manager of the specific venue location to create and modify the broadcast schedule of available live events at the specific physical venue location. In some implementations, the programs may be configured to track the popularity of each of said physical venue locations and the popularity of leading performers of said live events. In some implementations, the server 130 may be a cloud-based server.

In some implementations, the content delivery network server 130 may be configured to handle the communication with Internet users, process the incoming orders from Internet users, and maintain the billing data and orders of subscribers and pay-per-view customers, In some implementations, the content delivery network server 130 may be configured to allow an internet user watch selected live event(s) substantially in real-time by either paying subscription fees or paying pay-per-view fees. In some implementations, the content delivery network server 130 may be configured to provide a user menu for Internet users. The user menu may be associated with the broadcast schedule of available live events at the plurality of physical venue locations. The menu may be configured to allow a customer to view available live events, select interested live events, and order selected live event(s). In some implementations, the menu may be configured to allow the customer to modify and/or cancel the order by entering the order number. In some implementations, the server 130 may be configured to provide an option for a customer to set up his or her own personal account. The customer may log on his or her personal account to track, modify and/or cancel his or her order(s).

Those of skill of the art will recognize that the content delivery network server 130 may comprise a variety of servers. In some implementations, one or more of the variety of servers may be configured to receive and decode the encoded information of live events. One or more of the variety of servers may be configured to receive requests from network users and broadcast selected live events in substantially real-time to subscribers or paid customers. In some implementations, one or more of the variety of servers may be located at the same physical location. In some implementations, the variety of servers may be located at multiple physical locations.

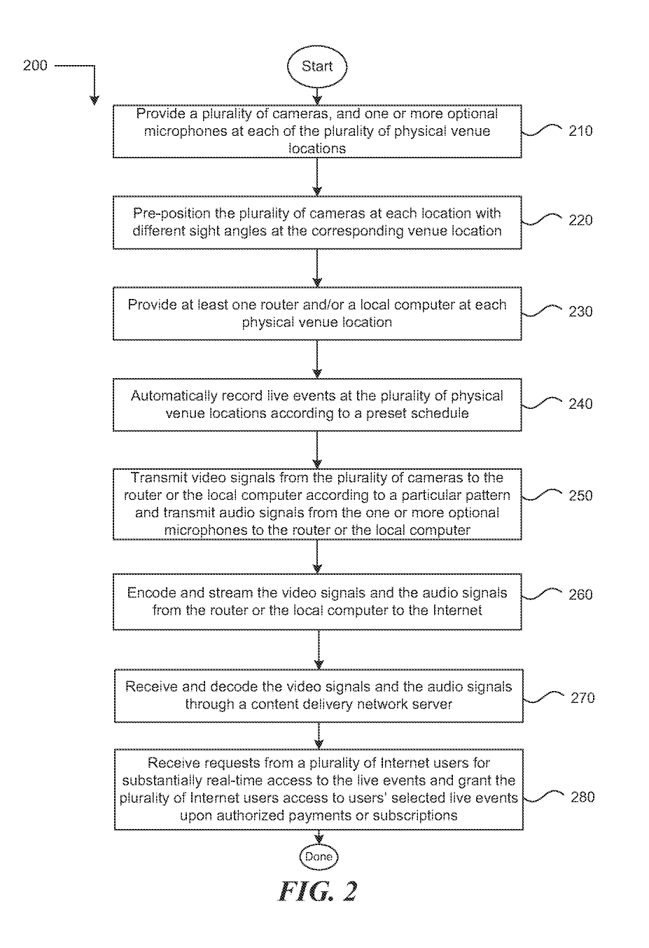

FIG. 2 illustrates a flow diagram of a process for automatically broadcasting live events on a network according to another embodiment(s) of the present disclosure. At step 210, a plurality of cameras 1104, and one or more optional microphones 1102 may be provided at each location of a plurality of physical venue locations. At step 220, the plurality of cameras 1104 at each physical venue location may be pre-positioned at different sight angles at the corresponding venue location. At least one camera of the plurality cameras 1104 may provide a shot of the entire stage and capture overall live events at each corresponding physical venue location. At least one router 1108 and/or a local computer are provided at each specific physical venue location, step 230. The at least one router 1108 or the local computer may have one or more IP address(es) and may be coupled to the plurality of cameras 1104 and one or more optional microphones 1102 via wired or wireless communications mechanisms in a manner well known in the art.

Live events at a specific physical venue location may be automatically recorded by the plurality of cameras 1104 and one or more optional microphones 1102 disposed at the specific venue location according to a preset schedule, step 240. The preset schedule may be created or modified by an operator of the content delivery network server 130 and/or a manager of the specific venue location. At the specific physical venue location, video signals may be transmitted from the plurality of cameras 1104 to the at least one router 1108 or the local computer according to a particular pattern while audio signals may be transmitted from the one or more optional microphones 1102 to the at least one router 1108 or the local computer, step 250. In some implementations, the video and audio signals may be combined and compressed by the at least one router 1108 or the local computer. In some implementations, the video and audio signals of the live event at the specific physical venue location may be encoded and streamed to a content delivery network server 130 through the at least one router 1108 or the local computer, step 260. Streamed video signals and audio signals may be received and decoded by the content delivery network server 130, 270. In some implementations, compressed video signals and audio signals are de-compressed by the content delivery network server 130.

In some implementations, a schedule of available live events at the plurality of physical venue locations 110 may be viewable to Internet users on the content delivery network server 130. The content delivery network server 130 may be configured to allow an internet user to select interest live event(s) from available live events and send the server a request to watch selected live event(s). At step 280, the request from the Internet user for access to the live event(s) is received at the content delivery network server 130 and access to the user selected live event(s) is granted upon authorized payment or subscription. In some implementations, a user menu associated with the schedule of available live events may be provided on the content delivery network server 130. The menu may be configured to allow a customer to modify or cancel his or her order by entering the order number. In some implementations, an option may be provided for a customer to set up his or her own personal account on the content delivery network server 130. The user may log on to his or her personal account to track, modify and/or cancel his or her prior order(s).

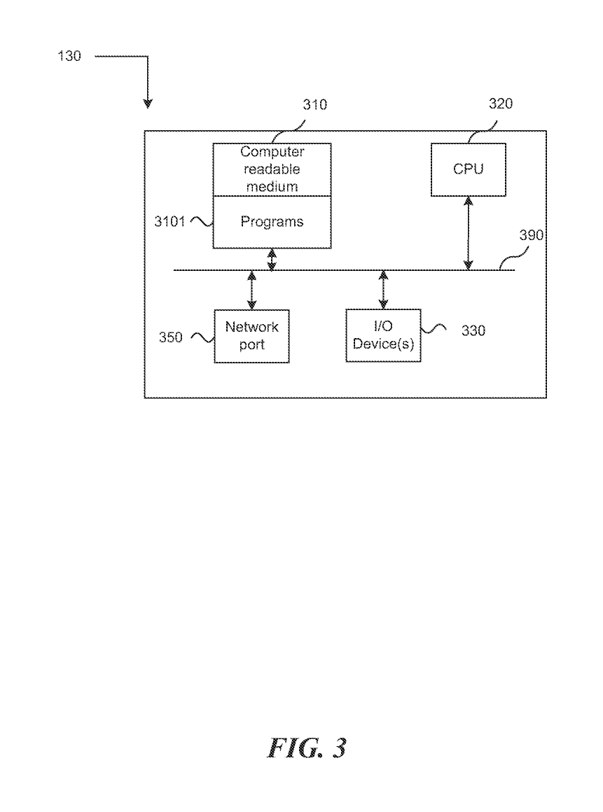

FIG. 3 illustrates a content delivery network server 130 according to yet another embodiment(s) of the present disclosure. The content delivery network server 130 may include at least a processor or a central processor unit (“CPU”) 320, one or more network port 350, one or more input/output (I/O) devices 330 such as a keyboard, touch screen or other touch input device, a display, speakers, printer etc., and one or more computer readable medium 310, all interconnected via one or more internal bus 390. The content delivery network server 130 preferably may include an operating system, such as but not limited to Windows™, Linux™, or Unix™. The computer readable medium 310 may be any medium device that is configured to store data, such as a hard drive, RAM, ROM, flash memory, electrically erasable program read-only memory (EEPROM), CD-ROM, digital versatile disks (DVD), or the like.

Programs 3101 are stored on the computer readable medium 310. The programs 3101 may be configured to allow an operator of the content delivery network server 130 or a manager of the specific venue location to create and/or modify a broadcast schedule of available live events at each specific physical venue location. The programs 3101 may be configured to allow the server operator and/or the venue manager to preset the time and duration of a five event at the specific physical venue location. In some implementations, the programs 3101 may be configured to allow the server operator or the venue manager to preset a particular pattern for the plurality of cameras at the specific physical venue location to transmit captured images to the router or the local computer at the corresponding venue location. In some implementations, the automated broadcast program may be configured to allow the server operator and/or the venue manager to preset the pan angles, the tilt angles, and the zoom ratios of a specific camera at the corresponding physical venue location.

The programs 3101 that reside in the computer readable medium 310 may be configured to handle the communication with Internet users, process the incoming orders from customers, and maintain customers' billing data and orders. The programs 3101 may be configured to provide a user menu, associated with available live events at the plurality of physical venue locations, for a customer to place an order of selected live event(s) and modify and/or cancel the order by entering the order number. In some implementations, the programs 3101 may be configured to provide an option for a customer to set up his or her own personal account and to log on his or her personal account to track, modify, and/or cancel his or her prior orders. In some implementations, the programs 3101 may be configured to allow a server operator and/or a manager of a specific physical venue location to post on the content delivery network server 130 promotion(s) of available live event(s) at the specific venue location.

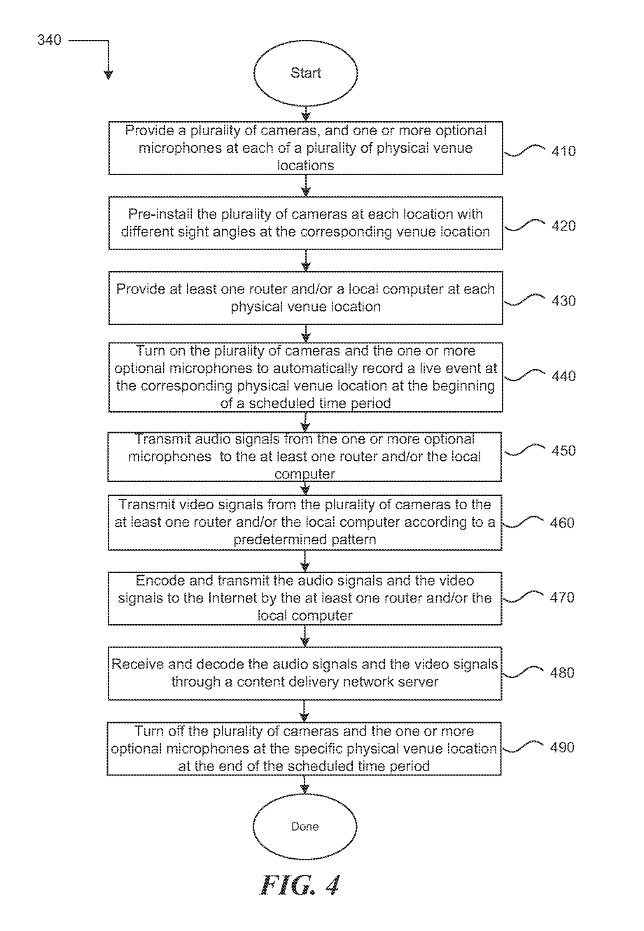

FIG. 4 illustrates a flow diagram of a process for automatically recording live events at a plurality of physical venues according to yet another embodiment(s) of the present disclosure. At step 410, a plurality of cameras, and one or more microphones may be provided at one location of a plurality of physical venue locations. At step 420, the plurality of cameras at a physical venue location may be pre-installed at different sight angles and adapted to the corresponding physical venue location. In some implementations, at least one cameras at one or more locations of the one or more physical venue locations may be configured to provide a shot of the entire stage and capture overall live events at the corresponding venue location. At step 430, at least one router and/or a local computer may be provided at each specific physical venue location. The at least one router or the local computer may have one or more IP addresses and may be coupled to the plurality of cameras and one or more optional microphones via wired or wireless communications mechanisms in a manner well known in the art.

At the beginning of a scheduled time period to automatically broadcast a live event, step 440, a plurality of cameras and one or more optional microphones at the corresponding physical venue location of the live event may be automatically turned on according to the programs 3101 stored on the computer readable medium 310. Audio signals may be transmitted from the one or more optional microphones to the at least one router and/or the local computer, step 450. Video signals may be transmitted from the plurality of cameras to the at least one router and/or the local computer according to a predetermined pattern, step 460. The programs 3101 may be configured to allow an operator of the content delivery network server 130 and/or a manager of the corresponding physical venue to preset the predetermined pattern. Video signals transmitted to the at least one router and/or the local computer may be automatically switched from one camera to another camera according to the predetermined pattern. For instance, broadcasted images of the live event may be automatically switched from images captured by one camera to those captured by another camera with a different sight angle after every fixed period of time, e.g. 30 seconds. In some implementations, the programs 3101 may be configured to allow an operator of the content delivery network server 130 or a manager of the corresponding physical venue to preset the pan angle, the tilt angle, and the zoom ratio of each camera at the corresponding physical venue location of the live event.

The audio signals and the video signals are encoded and transmitted to the content delivery network server 130 by the at least one router 1108 and/or the local computer at the corresponding physical venue location of the live event, step 470. In some implementations, the audio signals and the video signals may be combined and compressed by the at least one router 1108 and/or the local computer. Encoded audio and video signals may be received and decoded by the content delivery network server 130, step 480, In some implementations, if received signals are compressed, the compressed signals are de-compressed by the content delivery network server 130. At the end of the scheduled time period, the plurality of cameras and the one or more optional microphones at the specific physical venue of the live event may be automatically turned off, step 490.

The foregoing description has been presented with reference to specific embodiments for purposes of illustration and explanation. However, the illustrative discussions above are not intended to be exhaustive or to limit the invention to the embodiments described. A person skilled in the art may appreciate that many modifications and variations are possible in view of the present disclosure.

What is claimed is:

1. An automated broadcast system, comprising:
one or more automated broadcast sets, each automated broadcast set disposed on location at each of one or more physical venue locations, whereby each physical venue location is configured to host live events, said automated broadcast set comprising:
a plurality of cameras pre-positioned at different sight angles within a corresponding physical venue location, said plurality of cameras configured to automatically capture images from said live events;
at least one router or a local computer, located within said corresponding physical venue location, said at least one router or said local computer having one or more IP address(es), said at least one router or said local computer configured to receive video signals from said plurality of cameras and audio signals from said one or more microphones, said at least one router or said local computer operable for encoding said video signals over a network, and said at least one router or said local computer operable for transmitting encoded video signals; and
one or more content delivery network servers, said one or more content delivery network server having one or more IP addresses, said one or more content delivery network servers coupled to said network and configured to receive and decode said encoded video signals, said one or more content delivery network servers comprising computer programs, wherein said programs are configured to allow server operator(s) and/or venue manager(s) to schedule automated capture of said live events at said one or more physical venue locations, and said programs are configured to receive requests from a plurality of network users for substantially real-time access to said live events, and broadcast to said network users selected live events upon authorized payments or subscriptions.

2. A system as recited in claim 1, wherein said automated broadcast set comprises one or more optional microphones, pre-positioned at one or more locations of said one or more physical venue locations; said one or more optional microphones configured to automatically capture audio from said live events; said at least one router or said local computer operable for encoding said audio signals for transmission over a network, and said at least one router or said local computer operable for transmitting encoded audio signals over said network; said one or more content delivery network servers configured to receive and decode said encoded audio signals.

3. A system as recited in claim 2, wherein one of said one or more optional microphones at one or more locations of said one or more physical venue locations is pre-positioned to capture audio of audience at the corresponding venue location.

4. A system as recited in claim 1, wherein said one or more content network servers are located at the same physical location or located at multiple physical locations; at least one server of said one or more content network servers configured to allow said server operator(s) and/or said venue manager(s) to schedule automated capture of said live events; at least one server of said one or more content network servers configured to receive requests from said plurality of network users for substantially real-time access to said live events, and broadcast to said network users selected live events upon authorized payments or subscriptions.

5. A system as recited in claim 1, wherein at least one of said plurality of cameras at one or more locations of said one or more physical venue locations is pre-positioned to provide a wide shot of the entire stage of the corresponding venue location.

6. A system as recited in claim 1, wherein said programs are configured to allow said server operator(s) and/or said venue manager(s) to preset a particular pattern, whereby captured images of a live event are transmitted with said particular pattern from said plurality of cameras to said at least one router or said local computer at the corresponding venue location of said live event.

7. A system as recited in claim 6, wherein, according to said particular pattern, captured images, transmitted to said at least one router or said local computer, are switched between cameras at said corresponding venue location after every fixed period of time, whereby only one camera transmits captured images to said at least one router or said local computer at any given time during said live event.

8. A system as recited in claim 1, wherein said programs are configured to allow said server operator(s) and/or said venue manager(s) to preset the pan angle, the tilt angle, and the zoom ratio of a specific camera at the corresponding physical venue location.

9. A system as recited in claim 1, wherein said programs are configured to allow a customer to set up a personal account on said server, and provide said customer an option to track, modify and/or cancel prior order(s) by logging on said personal account.

10. A system as recited in claim 1, wherein said programs are configured to provide a user menu on said server, said user menu linked to available live events at said plurality of physical venue locations, said user menu configured to allow a customer to place an order of said available live events, said user menu configured to allow said customer to cancel or modify said order by entering the order number.

11. A system as recited in claim 10, wherein said programs are operable to convert captured images and audios of a live event into recordings, and said user menu is configured to provide an option for an interested customer to purchase one or more copies of said recordings by paying a particular price.

12. A system as recited in claim 1, wherein said automated broadcast set comprises one or more optional sensors, said one or more optional sensors operable to control live image and audio recorded and/or transmitted from said one or more physical venue locations.

13. A system as recited in claim 2, wherein said automated broadcast set includes a recorder, said recorder coupled to said plurality of cameras and said one or more optional microphones at the corresponding venue location, said recorder configured to store video signals and audio signals at said corresponding venue location when there is an unexpected Internet breakdown and/or a request of broadcast delays.

14. A method of automatically broadcasting live events on a network, comprising:
providing a plurality of cameras at each location of one or more physical venue locations; said a plurality of cameras configured to automatically record said live events;
pre-installing each plurality of cameras at different sight angles at each corresponding location of said one or more physical venue locations;
providing at least one router or a local computer at each corresponding physical venue location, said at least one router or said local computer having one or more IP address(es), said at least one router or said local computer configured to receive video signals from said plurality of cameras, said at least one router or said local computer operable for encoding said video signals for transmission over a network, and said at least one router or said local computer operable for transmitting encoded video signals over said network;
automatically recording said live events at said a plurality of physical venue locations according to a predetermined schedule, said predetermined schedule preset by server operator(s) or venue manager(s);
transmitting video signals from said plurality of cameras to said at least one router or said local computer according to a predetermined pattern, said predetermined pattern preset by said server operator(s) or said venue manager(s);
encoding said video signals for transmission over said network;
transmitting encoded video signals over said network;
receiving and decoding said encoded video signals through one or more content delivery network servers, wherein programs stored on said one or more content delivery network servers are configured to allow said server operator(s) or said venue manager(s) to preset said predetermined schedule;
receiving requests from a plurality of network users for access said live events; and
granting said plurality of network users access to selected live events upon authorized payments or subscriptions.

15. A method as recited in claim 14, further comprising:
providing one or more optional microphone(s) at one or more locations of said one or more physical venue locations, said one or more optional microphones configured to automatically record said live events;
transmitting audio signals from said one or more optional microphones to said at least one router or said local computer, said at least one router or said local computer configured to receive audio signals from said one or more optional microphone(s), said at least one router or said local computer configured to receive audio signals from said one or more optional microphone(s), said at least one router or said local computer operable for encoding and transmitting said audio signals for transmission over said network;
encoding said audio signals for transmission over said network;
transmitting encoded audio signals over said network; and
receiving and decoding said encoded audio signals through said one or more content delivery network servers.

16. A method as recited in claim 15, wherein one of said one or more microphones at one or more locations of said one or more physical venue locations is pre-positioned to capture audio of audience at the corresponding venue location.

17. A method as recited in claim 14, wherein said one or more content network servers are located at the same physical location or located at multiple physical locations; at least one server of said one or more content network servers configured to allow said server operator(s) and/or said venue manager(s) to schedule automated capture of said live events; at least one server of said one or more content network servers configured to receive requests from said plurality of network users for substantially real-time access to said live events, and broadcast to said network users selected live events upon authorized payments or subscriptions.

18. A method as recited in claim 14, wherein at least one of said plurality of cameras at one or more locations of said one or more physical venue locations is pre-positioned to provide a wide shot of the entire stage of the corresponding venue location.

19. A method as recited in claim 14, wherein said programs are configured to allow said server operator(s) or said venue manager(s) to preset a particular pattern, whereby captured images of a live event are transmitted with said particular pattern from said plurality of cameras to said at least one router or said local computer at the corresponding venue location of said live event.

20. A method as recited in claim 14, wherein, according to said particular pattern, captured images, transmitted to said at least one router or said local computer, are switched between cameras at said corresponding venue location after every fixed period of time, whereby only one camera transmits captured images to said at least one router or said local computer at any given time during said live event.

21. A method as recited in claim 14, wherein said programs are configured to allow said server operator(s) or said venue manager(s) to preset the pan angle, the tilt angle, and the zoom ratio of a specific camera at the corresponding physical venue location.

22. A method as recited in claim 19, wherein said programs are configured to allow a customer to set up a personal account on said server, and provide said customer an option to track, modify and/or cancel prior order(s) by logging to said personal account.

23. A method as recited in claim 14, wherein said programs are configured to provide a user menu on said server, said user menu linked to available live events at said plurality of physical venue locations, said user menu configured to allow a customer to place an order of said available live events, said user menu configured to allow said customer to cancel or modify said order by entering the order number.

24. A method as recited in claim 23, wherein said programs are operable to convert captured images and audios of a live event into recordings, and said user menu is configured to provide an option for an interested customer to purchase one or more copies of said recordings by paying a particular price.

25. A method as recited in claim 14, wherein said automated broadcast set comprises one or more optional sensors, said one or more optional sensors operable to control live image and audio recorded and/or transmitted from said one or more physical venue locations.

26. A method as recited in claim 15, wherein said automated broadcast set includes a recorder, said recorder coupled to said plurality of cameras and said one or more optional microphones at the corresponding venue location, said recorder configured to store video signals and audio signals at said corresponding venue location when there is an unexpected Internet breakdown and/or a request of broadcast delays.

27. An automated broadcast system, comprising:
a plurality of automated broadcast sets, each automated broadcast set disposed on location of one or more physical venue locations, whereby each physical venue location is configured to host live events, said each automated broadcast set comprising:
a plurality of cameras pre-installed at different sight angles within a corresponding physical venue location, said plurality of cameras configured to automatically capture images from said live events;
at least one router or a local computer, located within said corresponding physical venue location, said at least one router having one or more IP address(es), said at least one router configured to receive video signals from said plurality of cameras, said at least one router or said local computer operable for encoding said video signals for transmission over a network, and said at least one router or said local computer operable for transmitting encoded video signals over said network;
one or more content delivery network servers, said one or more content delivery network server having one or more IP addresses and coupled to said network; said content delivery network server including one or more computer readable medium and one or more programs stored on said computer readable medium, said programs configured to allow server operator(s) or venue manager(s) to schedule automated capture of said live events at said plurality of physical venue locations, said programs comprising:
instructions to turn on said plurality of cameras located at said corresponding physical venue location at the beginning of a scheduled time period;
instructions to transmit said video signals from said plurality of cameras to said at least one router or said local computer according to a predetermined pattern;
instructions to encode and transmit said video signals from said at least one router or said local computer to said content delivery network server; and
instructions to turn off said plurality of cameras located at said corresponding physical venue location at the end of said scheduled time period.

28. A system as recited in claim 27, wherein said automated broadcast set further comprises one or more optional microphones, pre-positioned at one or more locations of said one or more physical venue locations; said one or more optional microphones configured to automatically capture audio from said live events; said at least one router configured to receive audio signals from said one or more microphones, said at least one router or said local computer operable for encoding said audio signals for transmission over said network, and said at least one router or said local computer operable for transmitting encoded audio signals over said network; said programs further comprising:
instructions to turn on said one or more optional microphone(s) located at said corresponding physical venue location at the beginning of a scheduled time period;
instructions to transmit said audio signals from said one or more optional microphone(s) to said at least one router or said local computer;
instructions to encode and transmit said audio signals said at least one router or said local computer to said content delivery network server; and
instructions to turn off said one or more optional microphone(s) located at said corresponding physical venue location at the end of said scheduled time period.

29. A system as recited in claim 28, wherein one of said one or more microphones at one or more locations of said one or more physical venue locations is pre-positioned to capture audio of audience at the corresponding venue location.

30. A system as recited in claim 27, said programs further comprising instructions to receive requests from a plurality of network users for substantially real-time access to said live events, and instructions to broadcast to said network users selected live events upon authorized payments or subscriptions.

31. A system as recited in claim 30, wherein said one or more content network servers are located at the same physical location or located at multiple physical locations; at least one server of said one or more content network servers configured to allow said server operator(s) and/or said venue manager(s) to schedule automated capture of said live events; at least one server of said one or more content network servers configured to receive requests from said plurality of network users for substantially real-time access to said live events, and broadcast to said network users selected live events upon authorized payments or subscriptions.

32. A system as recited in claim 27, wherein at least one of said plurality of cameras at one or more locations of said one or more physical venue locations is pre-positioned to provide a wide shot of the entire stage of the corresponding venue location.

33. A system as recited in claim 27, wherein, according to said predetermined pattern, captured images of a live event being transmitted to said at least one router or said local computer, are switched between cameras at the corresponding physical venue location after every fixed period of time, whereby only one camera transmits captured images to said at least one router or said local computer at any given time during said live event.

34. A system as recited in claim 27, wherein said programs are configured to allow said server operator(s) and/or said venue manager(s) to preset the pan angle, the tilt angle, and the zoom ratio of a specific camera at the corresponding physical venue location.

35. A system as recited in claim 27, wherein said programs are configured to allow a customer to set up a personal account on said server, and provide said customer an option to track, modify and/or cancel prior order(s) by logging to said personal account.

36. A system as recited in claim 27, wherein said programs are configured to provide a user menu on said server, said user menu linked to available live events at said plurality of physical venue locations, said user menu configured to allow a customer to place an order of said available live events, said user menu configured to allow said customer to cancel and/or modify said order by entering the order number.

37. A system as recited in claim 36, wherein said programs are operable to convert captured images and audios of a live event into recordings, and said user menu is configured to provide an option for an interested customer to purchase one or more copies of said recordings by paying a particular price.

38. A system as recited in claim 27, wherein said automated broadcast set comprises one or more optional sensors, said one or more optional sensors operable to control live image and audio recorded and/or transmitted from said one or more physical venue locations.

39. A system as recited in claim 28, wherein said automated broadcast set includes a recorder, said recorder coupled to said plurality of cameras and said one or more optional microphones at the corresponding venue location, said recorder configured to store video signals and audio signals at said corresponding venue location when there is an unexpected Internet breakdown and/or a request of broadcast delays.

40. A method of automatically broadcasting live events on a network, comprising:
providing a plurality of cameras at each location of one or more physical venue locations; said a plurality of cameras configured to automatically record said live events:
pre-positioning each plurality of cameras at different sight angles at each corresponding location of said plurality of physical venue locations;
providing at least one router or a local computer at said each location, said at least one router or said local computer having one or more IP address(es), said at least one router or said local computer configured to receive video signals from said plurality of cameras, said at least one router or said local computer operable for encoding said video signals for transmission over a network, and said at least one router or said local computer operable for transmitting encoded video signals over said network;
turning on said plurality of cameras located at said corresponding physical venue location at the beginning of a scheduled time period;
transmitting video signals from said plurality of cameras to said at least one router or said local computer according to a predetermined pattern;
encoding said video signals for transmission over said network;
transmitting encoded video signals over said network;
receiving and decoding said encoded video signals through one or more content delivery network servers, wherein one or more program(s) stored on said one or more content delivery network servers are configured to allow server operator(s) or venue manager(s) to preset said scheduled time period and said predetermined pattern; and
turning off said plurality of cameras located at said corresponding physical venue location at the end of said scheduled time period.

41. A method as recited in claim 40, further comprising:
providing one or more optional microphone(s) at one or more locations of said one or more physical venue locations, said one or more optional microphones configured to automatically record said live events;
turning on said one or more optional microphone(s) located at said corresponding physical venue location at the beginning of said scheduled time period;
transmitting audio signals from said one or more optional microphones to said at least one router or said local computer, said at least one router or said local computer configured to receive audio signals from said one or more optional microphone(s), said at least one router or said local computer operable for encoding said video signals and said audio signals for transmission over said network, and said at least one router or said local computer operable for transmitting encoded video signals and encoded audio signals over said network;
encoding said audio signals for transmission over said network;
transmitting encoded audio signals over said network;
receiving and decoding said encoded audio signals through said one or more content delivery network servers; and
turning off said one or more optional microphone(s) located at said corresponding physical venue location at the end of said scheduled time period.

42. A method as recited in claim 41, wherein one of said one or more microphones at one or more locations of said one or more physical venue locations is pre-positioned to capture audio of audience at the corresponding venue location.

43. A method as recited in claim 42, wherein one of said one or more microphones at one or more physical venue location of said plurality of physical venue locations is pre-positioned to capture audio of audience at said one or more physical venue location.

44. A method as recited in claim 40, further comprising receiving requests from a plurality of network users for substantially real-time access to said live events, and broadcasting to said network users selected live events upon authorized payments or subscriptions.

45. A method as recited in claim 44, wherein said one or more content network servers are located at the same physical location or located at multiple physical locations; at least one server of said one or more content network servers configured to allow said server operator(s) and/or said venue manager(s) to schedule automated capture of said live events; at least one server of said one or more content network servers configured to receive requests from said plurality of network users for substantially real-time access to said live events, and broadcast to said network users selected live events upon authorized payments or subscriptions.

46. A method as recited in claim 40, wherein at least one of said plurality of cameras at one or more locations of said one or more physical venue locations is pre-positioned to provide a wide shot of the entire stage of the corresponding venue location.

47. A method as recited in claim 40, wherein, according to said predetermined pattern, captured images of a live event, transmitted to said at least one router or said local computer, are switched between cameras at the corresponding physical venue location after every fixed period of time, whereby only one camera transmits captured images to said at least one router or said local computer at any given time during said live event.

48. A method as recited in claim 40, wherein said programs are configured to allow said server operator(s) and/or said venue manager(s) to preset the pan angle, the tilt angle, and the zoom ratio of a specific camera at the corresponding physical venue location.

49. A method as recited in claim 40, wherein said programs are configured to allow a customer to set up a personal account on said server, and provide said customer an option to track, modify and/or cancel prior order(s) by logging to said personal account.

50. A method as recited in claim 40, wherein said programs are configured to provide a user menu on said server, said user menu linked to available live events at said plurality of physical venue locations, said user menu configured to allow a customer to place an order of said available live events, said user menu configured to allow said customer to cancel and/or modify said order by entering the order number.

51. A method as recited in claim 50, wherein said programs are operable to convert captured images and audios of a live event into recordings, and said user menu is configured to provide an option for an interested customer to purchase one or more copies of said recordings by paying a particular price.

52. A method as recited in claim 40, wherein said automated broadcast set comprises one or more optional sensors, said one or more optional sensors operable to control live image and audio recorded and/or transmitted from said one or more physical venue locations.

53. A method as recited in claim 41, wherein said automated broadcast set includes a recorder, said recorder coupled to said plurality of cameras and said one or more optional microphones at the corresponding venue location, said recorder configured to store video signals and audio signals at said corresponding venue location when there is an unexpected Internet breakdown and/or a request of broadcast delays.
